(19) United States
(12) Patent Application Publication
(10) Pub. No.: US 2021/0115192 A1
(43) Pub. Date: Apr. 22, 2021

(54) POLYIMIDE RESIN, PRODUCTION METHOD FOR POLYIMIDE RESIN, POLYIMIDE FILM, AND PRODUCTION METHOD FOR POLYIMIDE FILM

(71) Applicant: KANEKA CORPORATION, Osaka (JP)

(72) Inventors: Takahiro Yasumoto, Osaka (JP); Dong Zhang, Osaka (JP); Hiroyuki Ushiro, Osaka (JP); Yasutaka Kondo, Shiga (JP); Kohei Ogawa, Osaka (JP); Masahiro Miyamoto, Osaka (JP)

(73) Assignee: KANEKA CORPORATION, Osaka (JP)

(21) Appl. No.: 17/135,809

(22) Filed: Dec. 28, 2020

Related U.S. Application Data
(63) Continuation of application No. PCT/JP2019/024592, filed on Jun. 20, 2019.

(30) Foreign Application Priority Data
Jun. 28, 2018 (JP) 2018-123319
Aug. 30, 2018 (JP) 2018-161708
Aug. 30, 2018 (JP) 2018-161709
Dec. 5, 2018 (JP) 2018-228269
Dec. 5, 2018 (JP) 2018-228270

(51) Int. Cl. C08G 73/10; C08L 79/08

(52) U.S. Cl. CPC C08G 73/1067; C08G 73/1057; C08G 73/1032; C08L 2203/20; C08L 2201/08; C08L 2201/10; C08L 2203/16; C08L 79/08

(57) ABSTRACT

A polyimide resin has an acid dianhydride-derived structure and a diamine-derived structure, the acid dianhydride contains an acid dianhydride represented by the general formula (1) and a fluorine-containing aromatic acid dianhydride, and the diamine contains a fluoroalkyl-substituted benzidine. In the general formula (1), n is an integer of 1 or more, and R¹ to R⁴ are each independently a hydrogen atom, an alkyl group having 1 to 20 carbon atoms, or a perfluoroalkyl group having 1 to 20 carbon atoms. The content of the acid dianhydride represented by the general formula (1) may be 10 to 65 mol %, and the content of the fluorine-containing aromatic acid dianhydride may be 30 to 80 mol %, based on 100 mol % of the total of the acid dianhydride.

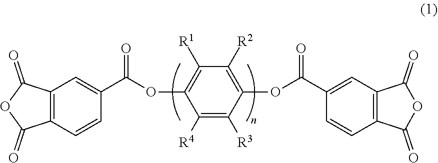

### TECHNICAL FIELD

One or more embodiments of the present invention relate to a polyimide resin, a production method for the polyimide resin, a polyimide solution, a polyimide film, and a production method for the polyimide film.

### BACKGROUND

Recently, with rapid progress of electronic devices, it has been required to make devices thinner, lighter and flexible. In particular, in applications where high heat resistance, dimensional stability at high temperatures and high mechanical strength are required, an attempt has been made to apply a polyimide film as a replacement for glass which is used for substrates, cover windows and the like.

Common polyimides are colored yellow or brown, and are not soluble in organic solvents. For forming a polyimide, which is insoluble in an organic solvent, into a film, a method has been employed in which a polyamic acid solution as a polyimide precursor is applied onto a substrate, the solvent is removed by heating, and the polyamic acid is cyclodehydrated (thermal imidization).

It is known that transparency to visible light and solubility can be imparted to a polyimide by introducing a cycloaliphatic structure, a bent structure, a fluorine substituent or the like. For example, Patent Document 1 indicates that a polyimide obtained using an ester group-containing monomer has excellent transparency and heat resistance, and is soluble in a wide range of solvents.

Such a polyimide soluble in an organic solvent can be formed into a film by applying a solution of the polyimide resin in an organic solvent (polyimide solution) onto a substrate, and removing the solvent by drying. A transparent and less colored polyimide film can be obtained by a method using a polyimide solution, but in this method, a solvent is more likely to remain on the polyimide film as compared to a thermal imidization method, which may cause a decrease in mechanical strength. On the other hand, when the polyimide film is heated at a high temperature for a long time for removing the residual solvent, the polyimide film is colored, resulting in deterioration of transparency.

Patent Document 2 discloses a polyimide obtained using a specific cycloaliphatic monomer, and indicates that since the polyimide is soluble in a low-boiling-point solvent such as dichloromethane, it is possible to prepare a polyimide film having a small residual solvent content.

### PATENT DOCUMENTS

Patent Document 1: International Publication No. WO 2014/046180

Patent Document 2: Japanese Patent Laid-Open No. 2016-132686

### SUMMARY

Studies by the present inventors have shown that a polyimide film obtained using a polyimide resin as in Patent Document 1 has a high yellowness index and insufficient transparency when the thickness of the polyimide is large as 40 μm or more. A polyimide obtained using a cycloaliphatic monomer (and polyamic acid as a precursor thereof as described in Patent Document 2 is likely to have a low polymerization degree. A polyimide film obtained using a polyimide resin having a low degree of polymerization (low molecular weight) may be poor in mechanical strength such as an elastic modulus or tensile strength.

One or more embodiments of the present invention are to provide a polyimide resin and a polyimide film which are soluble in a low-boiling-point solvent such as dichloromethane and excellent in transparency and mechanical strength.

### DETAILED DESCRIPTION OF THE EMBODIMENTS

A polyimide resin according to one or more embodiments of the present invention has an acid dianhydride-derived structure and a diamine-derived structure, and contains an acid dianhydride of general formula (1) and a fluorine-containing aromatic acid dianhydride as acid dianhydride, and a fluoroalkyl-substituted benzidine as diamine.

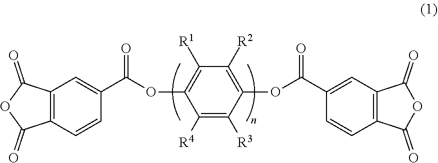

In general formula (1), n is an integer of 1 or more, and R¹ to R⁴ are each independently a hydrogen atom, an alkyl group having 1 to 20 carbon atoms, or a perfluoroalkyl group having 1 to 20 carbon atoms.

The amount of the acid dianhydride of general formula (1) may be 10 to 65 mol % based on 100 mol % of the total of the acid dianhydride. The amount of the fluorine-containing aromatic acid dianhydride may be 30 to 80 mol % based on 100 mol % of the total of acid dianhydride. The amount of the fluoroalkyl-substituted benzidine may be 40 to 100 mol % based on 100 mol % of the total of the diamine.

Specific examples of the acid dianhydride of general formula (1) include compounds of formula (2) and compounds of formula (3).

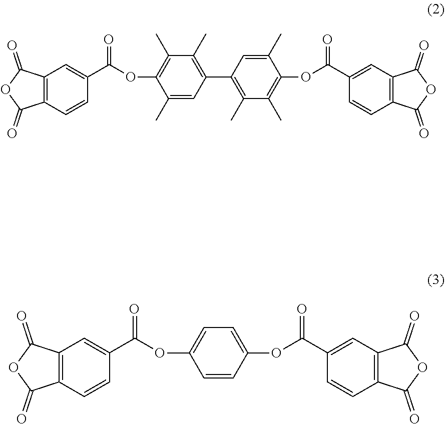

Specific examples of the fluorine-containing aromatic acid dianhydride include 2,2-bis(3,4-dicarboxyphenyl)-1,1,1,3,3,3-hexafluoropropanoic acid dianhydride. Specific examples of the fluoroalkyl-substituted benzidine include 2,2′-bis(trifluoromethyl)benzidine.

The polyimide may contain an acid dianhydride component or a diamine component other than those described above. Examples of acid dianhydrides other than those described above include 3,3′,4,4′-biphenyltetracarboxylic acid dianhydride. Examples of diamines other than those described above include 3,3′-diaminodiphenylsulfone.

The polyimide may contain an acid dianhydride having a biphenyl structure as an acid dianhydride component. The polyimide according to one or more embodiments contains 10 mol % or more of an acid dianhydride having a biphenyl structure based on 100 mol % of the total of the acid dianhydride, and a total of the acid dianhydride having a biphenyl structure, an acid dianhydride of general formula (1) and a fluorine-containing aromatic acid dianhydride is 80 mol % or more based on 100 mol % of the total of the acid dianhydride.

Specific examples of the acid dianhydride having a biphenyl structure include a compound of the formula (2) and 3,3′,4,4′-biphenyltetracarboxylic acid dianhydride.

The arrangement of monomer components (acid dianhydride-derived structure and diamine-derived structure) in the polyimide may be random or block. For example, the polyimide may contain in a molecular structure a block of successive repeating units in which an acid dianhydride of general formula (1) is bonded to a fluoroalkyl-substituted benzidine. For example, a block structure can be formed by reaction of acid dianhydride of general formula (1) and fluoroalkyl-substituted benzidine in a solution.

A polyimide film is obtained by dissolving a polyimide resin in a solvent to prepare a polyimide solution, applying the polyimide solution onto a substrate, and removing the solvent. The solvent for dissolving the polyimide may be a low-boiling-point solvent such as dichloromethane.

The thickness of the polyimide film may be 40 μm or more. The polyimide film may have a yellowness index of 2.5 or less, a tensile modulus of 3.5 GPa or more and a pencil hardness equal to or greater than H.

Since the polyimide resin of one or more embodiments of the present invention is soluble in a low-boiling-point solvent such as dichloromethane, and does not require heating at a high temperature to reduce the amount of a residual solvent, a polyimide film having high transparency can be obtained. The polyimide film of one or more embodiments of the present invention has high mechanical strength, and high transparency even with a large film thickness, and therefore can be used as a substrate material for displays, a cover window material, or the like.

[Polyimide Resin]

In general, polyimide is obtained by cyclodehydrogenation of polyamic acid obtained by reaction of tetracarboxylic acid dianhydride (hereinafter, sometimes referred to simply as “acid dianhydride”) and diamine. In other words, the polyimide has an acid dianhydride-derived structure and a diamine-derived structure. The polyimide resin of one or more embodiments of the present invention contains an ester group-containing acid dianhydride (bis-trimellitic anhydride ester) and a fluorine-containing aromatic acid dianhydride as acid dianhydride components, and a fluoroalkyl-substituted benzidine as a diamine component.

<Acid Dianhydride>

The polyimide of one or more embodiments of the present invention contains an ester group-containing acid dianhydride (bis-trimellitic anhydride ester) represented by general formula (1) below and a fluorine-containing aromatic acid dianhydride as acid dianhydrides.

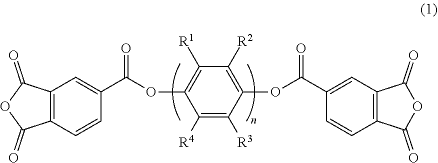

In general formula (1), n is an integer of 1 or more, and R¹ to R⁴ are each independently a hydrogen atom, an alkyl group having 1 to 20 carbon atoms, or a perfluoroalkyl group having 1 to 20 carbon atoms.

(Ester Group-Containing Acid Dianhydride)

The content of the acid dianhydride of general formula (1) above may be 10 to 65 mol %, 15 to 60 mol %, or 20 to 50 mol %, based on 100 mol % of the total of acid dianhydride components. When the content of the acid dianhydride of general formula (1) is 10 mol % or more, the polyimide film tends to have a high pencil hardness and elastic modulus. When the content of the acid dianhydride of general formula (1) is 65 mol % or less, the polyimide film tends to have high transparency. When the content of the acid dianhydride of general formula (1) is 65 mol % or less, marked thickening, gelation or the like can be suppressed during polymerization reaction of the polyamic acid and imidization reaction in the solution.

The acid dianhydride of general formula (1) is an ester (bis-trimellitic anhydride ester) of trimellitic anhydride and an aromatic diol. When the aromatic diol is a hydroquinone, a bis-trimellitic anhydride ester with n=1 in general formula (1) can be obtained. When the aromatic diol is a biphenol, a bis-trimellitic anhydride ester with n=2 in general formula (1) can be obtained.

Substituents R¹ to R⁴ in general formula (1) are each independently a hydrogen atom, an alkyl group having 1 to 20 carbon atoms, or a perfluoroalkyl group having 1 to 20 carbon atoms. When n is 2 or more, the substituents R¹ to R⁴ bonded to benzene rings may be the same or different. Specific examples of the alkyl group include a methyl group, an ethyl group, an n-propyl group, an isopropyl group, an n-butyl group, an isobutyl group, a t-butyl group, a cyclobutyl group, an n-pentyl group, an isopentyl group, a neopentyl group, a cyclopentyl group, an n-hexyl group and a cyclohexyl group. Specific examples of the perfluoroalkyl group include a trifluoromethyl group.

In general formula (1), n may be 1 or 2, and R¹ to R⁴ may be each independently a hydrogen atom, a methyl group or a trifluoromethyl group. Preferred examples of the acid dianhydride with n=2 in general formula (1) include bis(1,3-dioxo-1,3-dihydroisobenzofuran-5-carboxylic acid) 2,2′,3,3′,5,5′-hexamethylbiphenyl-4,4′-diyl of formula (2) (hereinafter, referred to as “TAHMBP”). Preferred examples of the acid dianhydride with n=1 in general formula (1) include p-phenylenebis(trimellitic acid monoester acid anhydride) of formula (3) (hereinafter, referred to as “TMHQ”).

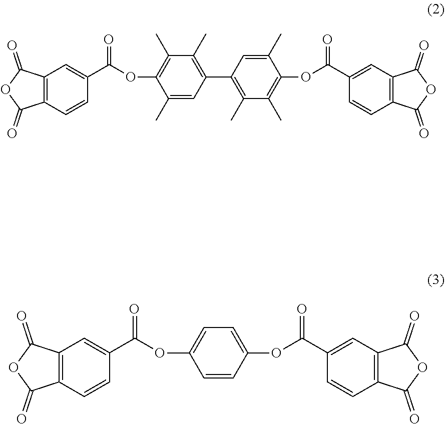

A polyimide containing the above-mentioned bis-trimellitic anhydride esters as acid dianhydrides tends to have high solubility in a low-boiling-point alkyl halide such as dichloromethane, and polyimide film tends to have high transparency and mechanical strength. TAHMBP of formula (2) has a biphenyl backbone having high rigidity and a bond between two benzene rings of biphenyl is twisted by steric hindrance between methyl groups, leading to a decrease in planarity of the n-conjugate. Therefore, the absorption edge wavelength shifts to shorter, thereby suppressing coloring of the polyimide.

(Fluorine-Containing Aromatic Acid Dianhydride)

The content of the fluorine-containing aromatic acid dianhydride may be 30 to 80 mol %, 35 to 75 mol %, or 45 to 75 mol %, based on 100 mol % of the total of acid dianhydride components. When the content of fluorine-containing aromatic acid dianhydride is 30 mol % or more, the polyimide film tends to have high transparency. When the content of fluorine-containing aromatic acid dianhydride is 80 mol % or less, the polyimide film tends to have a high pencil hardness and elastic modulus.

Examples of the fluorine-containing aromatic acid dianhydride include 2,2-bis(3,4-dicarboxyphenyl)-1,1,1,3,3,3-hexafluoropropanoic acid dianhydride, 2,2-bis(2,3-dicarboxyphenyl)-1,1,1,3,3,3-hexafluoropropane dianhydride, and 2,2-bis{4-[4-(1,2-dicarboxyphenyl)phenoxy]phenyl}-1,1,1,3,3,3-hexafluoropropane dianhydride. Of these, 2,2-bis(3,4-dicarboxyphenyl)-1,1,1,3,3,3-hexafluoropropanoic acid dianhydride (hereinafter, referred to as “6FDA”) is preferable.

(Other Acid Dianhydrides)

Acid dihydrate components other than those described above may be used in combination as long as solubility in a low-boiling-point solvent such as dichloromethane is not impaired, and as long as characteristics such as transparency and mechanical strength are not impaired. Examples of acid dianhydrides other than those described above include ethylenetetracarboxylic acid dianhydride, butanetetracarboxylic acid dianhydride, 1,2,3,4-cyclobutanetetracarboxylic acid dianhydride, 1,2,3,4-cyclopentanetetracarboxylic acid dianhydride, 1,2,4,5-cyclohexanetetracarboxylic acid dianhydride, 1,1′-bicyclohexane-3,3′,4,4′-tetracarboxylic acid dianhydride-3,4,3′,4′-dianhydride, 3.3′,4,4′-benzophenonetetracarboxylic acid dianhydride, 2,2′,3,3′-benzophenonetetracarboxylic acid dianhydride, 3,3′,4,4′-biphenyltetracarboxylic acid dianhydride, 2,2-bis(3,4-dicarboxyphenyl)propane dianhydride, 2,2-bis(2,3-dicarboxyphenyl)propane dianhydride, bis(3,4-dicarboxyphenyl)ether dianhydride, bis(3,4-dicarboxyphenyl)sulfone dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 1,3-bis[(3,4-dicarboxy)benzoyl]benzene dianhydride, 1,4-bis[(3,4-dicarboxy)benzoyl]benzene dianhydride, 2,2-bis{4-[4-(1,2-dicarboxy)phenoxy]phenyl}propane dianhydride, 2,2-bis{4-[3-(1,2-dicarboxy)phenoxy]phenyl}propane dianhydride, bis{4-[4-(1,2-dicarboxy)phenoxy]phenyl}ketone dianhydride, bis{4-[3-(1,2-dicarboxy)phenoxy]phenyl}ketone dianhydride, 4,4′-bis[4-(1,2-dicarboxy)phenoxy]biphenyl dianhydride, 4,4′-bis[3-(1,2-dicarboxy)phenoxy]biphenyl dianhydride, bis{4-[4-(1,2-dicarboxy)phenoxy]phenyl}ketone dianhydride, bis{4-[3-(1,2-dicarboxy)phenoxy]phenyl}ketone dianhydride, bis{4-[4-(1,2-dicarboxy)phenoxy]phenyl}sulfone dianhydride, bis{4-[3-(1,2-dicarboxy)phenoxy]phenyl}sulfone dianhydride, bis{4-[4-(1,2-dicarboxy)phenoxy]phenyl}sulfide dianhydride, bis{4-[3-(1,2-dicarboxy)phenoxy]phenyl}sulfide dianhydride, 2,2-bis{4-[3-(1,2-dicarboxy)phenoxy]phenyl}-1,1,1,3,3,3-propane dianhydride, 2,3,6,7-naphthalenetetracarboxylic acid dianhydride, 1,4,5,8-naphthalenetetracarboxylic acid dianhydride, 1,2,5,6-naphthalenetetracarboxylic acid dianhydride, 1,2,3,4-benzenetetracarboxylic acid dianhydride, 3,4,9,10-perylenetetracarboxylic acid dianhydride, 2,3,6,7-anthracenetetracarboxylic acid dianhydride and 1,2,7,8-phenyltetracarboxylic acid dianhydride.

For example, by using 3,3′,4,4′-biphenyltetracarboxylic acid dianhydride (hereinafter, referred to as “BPDA”) in addition to an acid dianhydride of general formula (1) and a fluorine-containing aromatic acid dianhydride as acid dianhydrides, a polyimide can be obtained which has a high elastic modulus and high transparency while maintaining solubility in a low-boiling-point solvent such as dichloromethane. The content of acid dianhydrides other than the acid dianhydride of general formula (1) above and the fluorine-containing aromatic acid dianhydride may be 50 mol % or less, or 30 mol % or less, based on 100 mol % of the total of acid dianhydride components. In other words, the total content of the acid dianhydride of general formula (1) above and the fluorine-containing aromatic acid dianhydride may be 50 mol % or more, or 70 mol % or more, based on 100 mol % of the total of acid dianhydride components.

<Diamine>

(Fluoroalkyl-Substituted Benzidine)

The polyimide of one or more embodiments of the present invention contains fluoroalkyl-substituted benzidine as diamine component. The content of the fluoroalkyl-substituted benzidine is 40 to 100 mol %, 50 mol % or more, or 60 mol % or more, based on 100 mol % of the total of diamine components. When the content of the fluoroalkyl-substituted benzidine is 40 mol % or more, the polyimide film tends to have a high pencil hardness and elastic modulus.

Examples of the fluoroalkyl-substituted benzidine include 2,2′-dimethylbenzidine, 2-fluorobenzidine, 3-fluorobenzidine, 2,3-difluorobenzidine, 2,5-difluorobenzidine, 2,6-difluorobenzidine, 2,3,5-trifluorobenzidine, 2,3,6-trifluorobenzidine, 2,3,5,6-tetrafluorobenzidine, 2,2′-difluorobenzidine, 3,3′-difluorobenzidine, 2,3′-difluorobenzidine, 2,2′,3-trifluorobenzidine, 2,3,3′-trifluorobenzidine, 2,2′,5-trifluorobenzidine, 2,2′,6-trifluorobenzidine, 2,3′,5-trifluorobenzidine, 2,3′,6,-trifluorobenzidine, 2,2′,3,3′-tetrafluorobenzidine, 2,2′,5,5′-tetrafluorobenzidine, 2,2′,6,6′-tetrafluorobenzidine, 2,2′,3,3′,6,6′-hexafluorobenzidine, 2,2′,3,3′,5,5′,6,6′-octafluorobenzidine, 2-(trifluoromethyl)benzidine, 3-(trifluoromethyl)benzidine, 2,3-bis(trifluoromethyl)benzidine, 2,5-bis(trifluoromethyl)benzidine, 2,6-bis(trifluoromethyl)benzidine, 2,3,5-tris(trifluoromethyl)benzidine, 2,3,6-tris(trifluoromethyl)benzidine, 2,3,5,6-tetrakis(trifluoro)methyl)benzidine, 2,2′-bis(trifluoromethyl)benzidine, 3,3′-bis(trifluoromethyl)benzidine, 2,3′-bis(trifluoromethyl)benzidine, 2,2′,3-bis(trifluoromethyl)benzidine, 2,3,3′-tris(trifluoromethyl)benzidine, 2,2′,5-tris(trifluoromethyl)benzidine, 2,2′,6-tris(trifluoromethyl)benzidine, 2,3′,5-tris(trifluoromethyl)benzidine, 2,3′,6,-tris (trifluoromethyl)benzidine, 2,2′,3,3′-tetrakis(trifluoromethyl)benzidine, 2,2′,5,5′-tetrakis(trifluoromethyl)benzidine, and 2,2′,6,6′-tetrakis(trifluoromethyl)benzidine.

Of these, a fluoroalkyl-substituted benzidine having a fluoroalkyl group at the 2-position of biphenyl is preferable, and 2,2′-bis(trifluoromethyl)benzidine (hereinafter, referred to as “TFMB”) is particularly preferable. When fluoroalkyl groups are present at the 2-position and 2′-position of biphenyl, the π-electron density decreases due to the electron-withdrawing property of the fluoroalkyl group, and a bond between two benzene rings of biphenyl is twisted by steric hindrance of the fluoroalkyl group, leading to a decrease in planarity of the n-conjugate. Therefore, the absorption edge wavelength shifts to shorter, thereby suppressing coloring of the polyimide.

(Other Diamines)

Diamines other than those described above may be used in combination as long as solubility in a low-boiling-point solvent such as dichloromethane is not impaired, and as long as characteristics such as transparency and mechanical strength are not impaired. Examples of the diamine other than fluoroalkyl-substituted benzidines include p-phenylenediamine, m-phenylenediamine, o-phenylenediamine, 3,3′-diaminodiphenyl ether, 3,4′-diaminodiphenyl ether, 4,4′-diaminodiphenyl ether, 3,3′-diaminodiphenyl sulfide, 3,4′-diaminodiphenyl sulfide, 4,4′-diaminodiphenyl sulfide, 3,3′-diaminodiphenylsulfone, 3,4′-diaminodiphenylsulfone, 4,4′-diaminodiphenylsulfone, 3,3′-diaminobenzophenone, 4,4′-diaminobenzophenone, 3,4′-diaminobenzophenone, 3,3′-diaminodiphenylmethane, 4,4′-diaminodiphenylmethane, 3,4′-diaminodiphenylmethane, 2,2-di(3-aminophenyl)propane, 2,2-di(4-aminophenyl)propane, 2-(3-aminophenyl)-2-(4-aminophenyl)propane, 1,1-di(3-aminophenyl)-1-phenylethane, 1,1-di(4-aminophenyl)-1-phenylethane, 1-(3-aminophenyl)-1-(4-aminophenyl)-1-phenylethane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,3-bis(3-aminobenzoyl)benzene, 1,3-bis(4-aminobenzoyl)benzene, 1,4-bis(3-aminobenzoyl)benzene, 1,4-bis(4-aminobenzoyl)benzene, 1,3-bis(3-amino-α,α-dimethylbenzyl)benzene, 1,3-bis(4-amino-α,α-dimethylbenzyl)benzene, 1,4-bis(3-amino-α,α-dimethylbenzyl)benzene, 1,4-bis(4-amino-α,α-dimethylbenzyl)benzene, 2,6-bis(3-aminophenoxy)benzonitrile, 2,6-bis(3-aminophenoxy)pyridine, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 2,2-bis[4-(3-aminophenoxy)phenyl]propane, 2,2-bis[4-(4-aminophenoxy)phenyl]propane, 1,3-bis[4-(3-aminophenoxy)benzoyl]benzene, 1,3-bis[4-(4-aminophenoxy)benzoyl]benzene, 1,4-bis[4-(3-aminophenoxy)benzoyl]benzene, 1,4-bis[4-(4-aminophenoxy)benzoyl]benzene, 1,3-bis[4-(3-aminophenoxy)-α,α-dimethylbenzyl]benzene, 1,3-bis[4-(4-aminophenoxy)-α,α-dimethylbenzyl]benzene, 1,4-bis[4-(3-aminophenoxy)-α,α-dimethylbenzyl]benzene, 1,4-bis[4-(4-aminophenoxy)-α,α-dimethylbenzyl]benzene, 4,4′-bis[4-(4-aminophenoxy)benzoyl]diphenyl ether, 4,4′-bis[4-(4-amino-α,α-dimethylbenzyl)phenoxy]benzophenone, 4,4′-bis[4-(4-amino-α,α-dimethylbenzyl)phenoxy]diphenylsulfone, 4,4′-bis[4-(4-aminophenoxy)phenoxy]diphenylsulfone, 3,3′-diamino-4,4′-diphenoxybenzophenone, 3,3′-diamino-4,4′-dibiphenoxybenzophenone, 3,3′-diamino-4-phenoxybenzophenone, 3,3′-diamino-4-phenoxybenzophenone, 6,6′-bis(3-aminophenoxy)-3,3,3′,3′-tetramethyl-1,1′-spirobiindan, 6,6′-bis(4-aminophenoxy)-3,3,3′,3′-tetramethyl-1,1′-spirobiindan, 1,3-bis(3-aminopropyl)tetramethyldisiloxane, 1,3-bis(4-aminobutyl)tetramethyldisiloxane, α,ω-bis(3-aminopropyl)polydimethylsiloxane, α,ω-bis(3-aminobutyl)polydimethylsiloxane, bis(aminomethyl)ether, bis(2-aminoethyl)ether, bis(3-aminopropyl)ether, bis(2-aminomethoxy)ethyl]ether, bis[2-(2-aminoethoxy)ethyl]ether, bis[2-(3-aminoprotoxy)ethyl]ether, 1,2-bis(aminomethoxy)ethane, 1,2-bis(2-aminoethoxy)ethane, 1,2-bis[2-(aminomethoxy)ethoxy]ethane, 1,2-bis[2-(2-aminoethoxy)ethoxy]ethane, ethylene glycol bis(3-aminopropyl)ether, diethylene glycol bis(3-aminopropyl)ether, triethylene glycol bis(3-aminopropyl)ether, ethylenediamine, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, 1,12-diaminododecane, 1,2-diaminocyclohexane, 1,3-diaminocyclohexane, 1,4-diaminocyclohexane, trans-1,4-diaminocyclohexane, 1,2-di(2-aminoethyl)cyclohexane, 1,3-di(2-aminoethyl)cyclohexane, 1,4-di(2-aminoethyl)cyclohexane, bis(4-aminocyclohexyl)methane, 2,6-bis(aminomethyl)bicyclo[2.2.1]heptane, 2,5-bis(aminomethyl)bicyclo[2.2.1]heptane, 1,4-diamino-2-fluorobenzene, 1,4-diamino-2,3-difluorobenzene, 1,4-diamino-2,5-difluorobenzene, 1,4-diamino-2,6-difluorobenzene, 1,4-diamino-2,3,5-trifluorobenzene, 1,4-diamino-2,3,5,6-tetrafluorobenzene, 1,4-diamino-2-(trifluoromethyl)benzene, 1,4-diamino-2,3-bis(trifluoromethyl)benzene, 1,4-diamino-2,5-bis(trifluoromethyl)benzene, 1,4-diamino-2,6-bis(trifluoromethyl)benzene, 1,4-diamino-2,3,5-tris(trifluoromethyl)benzene, and 1,4-diamino-2,3,5,6-tetrakis(trifluoromethyl)benzene.

For example, by using 3,3′-diaminodiphenylsulfone (hereinafter referred to as “3,3′-DDS”) in addition to the fluoroalkyl-substituted benzidine as diamines, the solvent-solubility and the transparency of the polyimide resin may be improved. The content of 3,3′-DDS based on 100 mol % of the total of the diamines may be 5 mol % or more, or 10 mol % or more. The content of 3,3′-DDS may be 15 mol % or more, 20 mol % or more, or 25 mol % or more. From the viewpoint of the mechanical strength of the polyimide resin, the content of 3,3′-DDS based on 100 mol % of the total of the diamines may be 50 mol % or less, 40 mol % or less, or 35 mol % or less.

<Composition of Polyimide>

As described above, the polyimide resin of one or more embodiments of the present invention contains an acid dianhydride of general formula (1) and a fluorine-containing aromatic acid dianhydride as acid dianhydride components, and a fluoroalkyl-substituted benzidine as diamine component. The acid dianhydride of general formula (1) may be TAHMBP of formula (2) and/or TMHQ of formula (3), and the fluorine-containing aromatic acid dianhydride may be 6FDA, and TFMB may be a fluoroalkyl-substituted benzidine. The polyimide may further contain BPDA as acid dianhydride component, and may further contain 3,3′-DDS as diamine component.

The amount of acid dianhydride of general formula (1) may be 15 to 65 mol %, and the total amount of TAHMBP and TMHQ may be 15 to 65 mol %, based on 100 mol % of the total of acid dianhydride components. It is preferable that the amount of the acid dianhydride of general formula (1) is 20 to 65 mol %, and it is further preferable that the total amount of TAHMBP and TMHQ is 20 to 65 mol %. The amount of 6FDA may be 30 to 80 mol %, or 35 to 60 mol %, based on 100 mol % of the total of acid dianhydride components. Further, 10 to 40 mol % of BPDA may be present as acid dianhydride component.

The amount of TFMB may be 40 to 100 mol %, or 60 to 80 mol %, based on 100 mol % of the total of diamine components, 60 mol % or less of 3,3′-DDS may be present based on 100 mol % of the total of diamine components, and the content of 3,3′-DDS may be 20 to 40 mol %.

In one or more embodiments of the present invention, the polyimide resin contains acid dianhydride component having a biphenyl structure. Since the acid dianhydride component has a biphenyl structure, the ultraviolet resistance property of the polyimide film tends to be enhanced, leading to suppression of a decrease in transparency (an increase in yellowness index YI) due to ultraviolet irradiation.

In order to suppress photodegradation of the transparent resin, an ultraviolet absorber is generally added. However, if the amount of the ultraviolet absorber is increased in order to enhance the ultraviolet resistance of the transparent polyimide film, the yellowness index may increase due to coloring of the film, or heat resistance may be deteriorated. When an acid dianhydride having a biphenyl structure is used as acid dianhydride component of the polyimide, even if the ultraviolet absorber is not used or the amount of the ultraviolet absorber added is small, the polyimide film has ultraviolet resistance sufficient to suppress coloring that may be caused by an ultraviolet absorber. Therefore, both excellent transparency and excellent ultraviolet resistance can be achieved.

From the viewpoint of improving the ultraviolet resistance of the polyimide film, the content of the acid dianhydride having a biphenyl structure may be 10 mol % or more, 15 mol % or more, or 20 mol % or more, based on 100 mol % of the total of acid dianhydride components. From the viewpoint of securing both transparence and ultraviolet resistance, and imparting excellent mechanical strength, and solubility in a low-boiling-point solvent such as dichloromethane, the total content of the acid dianhydride having a biphenyl structure, the acid dianhydride of general formula (1) and the fluorine-containing aromatic acid dianhydride may be 80 mol % or more, 85 mol % or more, 90 mol % or more, even or 95 mol % or more, based on 100 mol % of the total of acid dianhydride components.

Examples of the acid dianhydride having a biphenyl structure include compounds with n=2 in general formula (1), such as TAHMBP. TAHMBP is acid dianhydride of general formula (1), and corresponds to acid dianhydride having a biphenyl structure.

Ina polyimide containing a compound with n=2 in general formula (1) as the acid dianhydride having a biphenyl structure, the content of TAHMBP may be 15 to 65 mol %, 20 to 65 mol %, or 30 to 60 mol %, based on 100 mol % of the total of acid dianhydride components the content of 6FDA may be 30 to 80 mol %, 30 to 70 mol %, or 35 to 60 mol %, based on 100 mol % of the total of acid dianhydride components; the content of TFMB may be 40 to 100 mol %, 50 to 90 mol %, or 60 to 80 mol %, based on 100 mol % of diamine components; and the content of 3,3′-DDS may be 60 mol % or less, 10 to 50 mol %, or 20 to 40 mol %, based on 100 mol % of diamine components.

Further, an acid dianhydride with n being a number other than 2 in general formula (1), such as TMHQ (i.e., a compound having no biphenyl structure) may be used in combination. As the acid dianhydride having a biphenyl structure, BPDA or the like may be used in combination with the acid dianhydride of general formula (1), such as TAHMBP.

As the acid dianhydride having a biphenyl structure, a compound other than the acid dianhydride of general formula (1) may be used. For example, the polyimide contains BPDA as the acid dianhydride component having a biphenyl structure, TMHQ as the acid dianhydride component of general formula (1), and 6FDA as the fluorine-containing aromatic acid dianhydride.

In a polyimide containing BPDA, TMHQ and 6FDA as acid dianhydride components, the content of BPDA may be 10 to 50 mol %, 15 to 45 mol %, or 20 to 40 mol %, based on 100 mol % of the total of acid dianhydride components; the content of TMHQ may be 10 to 65 mol %, 15 to 60 mol %, or 20 to 50 mol %, based on 100 mol % of acid dianhydride components; the content of 6FDA may be 30 to 80 mol %, 35 to 70 mol %, or 40 to 60 mol %, based on 100 mol % of the total of acid dianhydride components; the content of TFMB may be 40 to 100 mol %, 50 to 90 mol %, or 60 to 80 mol %, based on 100 mol % of diamine components; and the content of 3,3′-DDS may be 60 mol % or less, 10 to 50 mol %, or 20 to 40 mol %, based on 100 mol % of diamine components.

When the above-described combination of the acid dianhydrides and the diamines is used, and the acid dianhydride components and the diamine components are respectively set within the above-described ranges, a polyimide can be obtained which has high solubility in a low-boiling-point solvent such as dichloromethane, allows the residual solvent to be reduced, and is excellent in transparency and mechanical strength.

[Production Method for Polyimide Resin]

The production method for the polyimide resin is not particularly limited. A method is preferable in which diamine and acid dianhydride are reacted in a solvent to prepare a polyamic acid as a polyimide precursor, and the polyamic acid is imidized by cyclodehydration of the polyamic acid. A polyimide solution can be obtained by, for example, adding an imidization catalyst and a dehydration agent to a polyamic acid solution to cause cyclodehydration of the polyamic acid. A polyimide resin can be obtained by mixing the polyimide solution and a poor solvent for polyimide to precipitate a polyimide resin, and performing solid-liquid separation.

<Preparation of Polyamic Acid>

A polyamic acid solution can be obtained by reaction of acid dianhydride and diamine in a solvent. For polymerization of the polyamic acid, diamine and acid dianhydride as raw materials, and organic solvent capable of dissolving the polyamic acid as a polymerization product can be used without particular limitation. Specific examples of the organic solvent used for polymerization of the polyamic acid include urea-based solvents such as methylurea and N,N-dimethylethylurea; sulfone-based solvents such as dimethyl sulfoxide, diphenylsulfone and tetramethylsulfone; amide-based solvents such as N,N-dimethyl, N,N-dimethylformamide, N,N′-diethylacetamide, N-methyl-2-pyrrolidone, γ-butyrolactone and hexamethylphosphoric triamide; alkyl halide-based solvents such as chloroform and dichloromethane; aromatic hydrocarbon-based solvents such as benzene and toluene; and ether-based solvents such as tetrahydrofuran, 1,3-dioxolane, 1,4-dioxane, dimethyl ether, diethyl ether and p-cresol methyl ether. One of these solvents may be used alone, or two or more thereof may be used in combination as appropriate. Of these, N,N-dimethylacetamide, N,N-dimethylformamide, or N-methylpyrrolidone may be used because it is excellent in polymerization reactivity and polyamic acid solubilizing property.

When the diamine and the acid dianhydride are dissolved in an organic solvent, polymerization of polyamic acid proceeds. The solid content concentration of the polyamic acid solution (the concentration of diamine and acid dianhydride added in the reaction solution) may be typically about 5 to 40 wt %, or 10 to 30 wt %. It is preferable to use equimolar amounts (95:105 to 105:95) of the acid dianhydride and the diamine. If the amount of any one of the components is excessive, the mechanical strength of the polyimide film may decrease because the molecular weights of the polyamic acid and the polyimide do not become sufficiently large.

The reaction temperature is not particularly limited, and may be 0° C. or higher and 80° C. or lower, and or 20° C. or higher and 45° C. or lower. By setting the reaction temperature to 0° C. or higher, a decrease in reaction rate can be suppressed, so that polymerization reaction can be carried out in a relatively short time. By setting the reaction temperature to 80° C. or lower, a decrease in degree of polymerization due to ring-opening of the acid dianhydride component.

The order of adding diamine and acid dianhydride to the organic solvent (reaction system) in polymerization of the polyamic acid is not particularly limited. For example, the diamine is dissolved in an organic solvent or dispersed in a slurry form to obtain a diamine solution, and the acid dianhydride is added to the diamine solution. The diamine may be added to a solution of the acid dianhydride in a polar organic solvent. A plurality of acid dianhydrides and diamines may be added at one time, or may be added in a plurality of times. The diamine and the acid dianhydride may be added in a solid state, or added in a state of being dissolved or dispersed in a slurry form in an organic solvent.

(Formation of Block Structure)

By adjusting the order of adding the monomers, various physical properties of the resulting polyimide can be controlled. For example, among a plurality of acid dianhydrides and diamines, a specific acid dianhydride and diamine are first reacted to form a segment (block structure) having successive structural units (repeating units) in which a specific acid dianhydride and a specific diamine are bonded. By causing the reaction to further proceed by adding the remaining diamine and acid dianhydride after formation of the block structure, a polyamic acid can be obtained which contains a block structure in the molecule. By imidizing the polyamic acid, a polyimide can be obtained which contains in a molecular structure a block having successive structural units in which a specific diamine and a specific acid dianhydride are bonded.

For example, reaction of the acid dianhydride of general formula (1) and the fluoroalkyl-substituted benzidine in an organic solvent enables formation of a block having successive structural units in which the acid dianhydride of general formula (1) and a fluoroalkyl-substituted benzidine are bonded. A polyimide containing such a block structure exhibits excellent solubility in a low-boiling-point solvent such as dichloromethane as in the case of a polyimide having random sequence of monomers, and tends to give a polyimide film with higher mechanical strength (particularly in elastic modulus) as compared to a polyimide having random sequence of monomers.

In particular, a polyimide having a block having successive structural units in which a compound with n=2 in general formula (1) (e.g. TAHMBP) and a fluoroalkyl-substituted benzidine such as TFMB are bonded tends to have high mechanical strength. This may be because TAHMBP as acid dianhydride component and TFMB as diamine component each has a biphenyl structure, and a block in which these components are bonded to each other acts as a hard segment with high rigidity.

The number of successive structural units (repeating units) in the block may be 5 or more, or 7 or more. The number of successive repeating units in the block can be adjusted by, for example, the ratio of the amounts of acid dianhydride and diamine in terms of a molar ratio. The number of successive repeating units tends to increase as the ratio of the amounts of acid dianhydride and diamine in terms of a molar ratio becomes closer to 1:1. For obtaining a sufficiently large number of successive repeating units, the amount of the diamine during formation of the block may be 0.75 to 1.25 times, 0.8 to 1.2 times, or 0.85 to 1.15 times the amount of the acid dianhydride in terms of a molar ratio.

If an acid anhydride group is present at the end of a block chain, depolymerization easily occurs, so that the number of successive repeating units may decrease, or the block chain may change to a random form. When a block having an amine at the end is formed with the diamine in an amount larger than the amount of the acid dianhydride, depolymerization can be suppressed. From the viewpoint of increasing the number of successive repeating units in the block and suppressing depolymerization of the block, the amount of the diamine during formation of the block may be 1.01 to 1.25 times, 1.03 to 1.2 times, or 1.05 to 1.15 times the amount of the acid dianhydride in terms of a molar ratio.

(Preparation of Polyamic Acid by Reaction of Prepolymer and Oligomer)

Adjustment of the order of adding monomers in polymerization of the polyamic acid enables control of the molecular weight, and adjustment of reactivity and the solution viscosity, in addition to control of arrangement (sequences) of monomers. For example, molecular weight may be adjusted within a specific range when a prepolymer is formed by reaction of the acid dianhydride and the diamine with one of these components added in an excessive amount, and then post-polymerization is performed with the remaining monomers added in such a manner that the amounts of the acid dianhydride and the diamine are substantially equal to each other in terms of moles. The molecular weight tends to increase as the amounts of the acid dianhydride and the diamine in terms of moles during formation of the prepolymer become closer to each other.

In post-polymerization after formation of the prepolymer, the remaining acid dianhydride and diamine may be added simultaneously or sequentially. An oligomer (solution) obtained by reaction of remaining acid dianhydride and diamine may be added to the prepolymer solution. For example, an acid dianhydride having low solubility in a solvent for polymerization is reacted with a diamine to prepare an acid anhydride-terminated oligomer (solution), and an amine-terminated prepolymer solution and the acid-terminated oligomer solution are mixed and reacted.

Acid dianhydride has lower solubility in a solvent for polymerization as compared to diamine in general, and it is difficult to say that bis-trimellitic anhydride ester of general formula (1), fluorine-containing aromatic acid dianhydrides such as 6FDA, and acid dianhydrides such as BPDA have sufficient solubility in a polymerization solvent such as DMF. When an acid dianhydride having low solubility is added to a prepolymer solution, it may take a long time until the acid dianhydride is dissolved and reacted. In addition, if an insoluble acid dianhydride remains in the reaction system, the polyimide may have a poor mechanical strength because the molecular weight does not sufficiently increase, or an unexpected change in viscosity, which is caused by the insoluble acid dianhydride, occurs.

When an acid dianhydride with low solubility is reacted with a diamine to prepare an acid anhydride-terminated oligomer in advance, and the oligomer solution is mixed with an amine-terminated prepolymer, it is possible to homogenize the reaction system. By using the oligomer solution, the reaction time can be made shorter as compared to a case where the acid dianhydride is added to the reaction system. In addition, use of the oligomer solution enables suppression of a decrease in molecular weight and an unexpected change in viscosity, which may be caused by insoluble acid dianhydride.

A method for preparing a polyamic acid solution by mixing an amine-terminated prepolymer solution with an acid-terminated oligomer solution includes the steps of (1) reacting a diamine with an acid dianhydride to synthesize an amine-terminated polyamic acid (prepolymer); (2) reacting the diamine with the acid dianhydride to synthesize an acid-terminated polyamic acid (oligomer); and (3) mixing a solution of the amine-terminated prepolymer obtained in step (1) with a solution of the acid anhydride-terminated oligomer obtained in step (2) to react the prepolymer with the oligomer.

The total amount of the acid dianhydrides (the total of the amount of the acid dianhydride in step (1) and the amount of the acid dianhydride in step (2)) may be 0.95 to 1.05 times the total amount of the diamines (the total of the amount of the diamine in step (1) and the amount of the diamine in step (2)), in terms of a molar ratio. The amount of the acid dianhydride in step (2) may be 0.001 to 0.25 times the total amount of the acid dianhydrides.

In Step (1): preparation of the prepolymer, an amine-terminated polyamic acid (prepolymer) can be obtained by setting the amount of the diamine being larger than the amount of the acid dianhydride. The amount of the acid dianhydride in preparation of the prepolymer may be 0.9 to 0.99 times, or 0.93 to 0.98 times the amount of the diamine, in terms of a molar ratio. In preparation of the prepolymer, the acid dianhydride and the diamine may be added to the solvent at one time or in a plurality of additions. As described above, a specific acid dianhydride and diamine may be first reacted to form a block in which specific structural units are arranged successively, followed by adding the remaining acid dianhydride and diamine.

In Step (2): preparation of the oligomer an acid anhydride-terminated polyamic acid (oligomer) can be obtained by reacting the diamine with an excessive amount of the acid dianhydride with respect to the diamine. In preparation of the oligomer, the amount of the acid dianhydride may be 1.1 times or more, 1.3 times or more, or 1.5 times or more the amount of the diamine, in terms of a molar ratio. The amount of the acid dianhydride may be twice or more the amount of the diamine, but if the molar ratio of the acid dianhydride to the diamine is more than 2, an unreacted acid dianhydride is likely to remain. Therefore, in preparation of the oligomer, the amount of the acid dianhydride may be 2.1 times or less, or 2 times or less the amount of the diamine, in terms of a molar ratio.

In step (3), reaction between the prepolymer and the oligomer is caused to proceed by mixing the amine-terminated prepolymer solution and the acid anhydride-terminated oligomer solution.

The amount of the acid dianhydride used for preparation of the oligomer (step (2)) may be 0.001 to 0.25 times, 0.003 to 0.2 times, or 0.005 to 0.18 times the total amount of the acid dianhydride (the total of the acid dianhydride used for preparation of the prepolymer and the acid dianhydride used for preparation of the oligomer), in terms of a molar ratio. The amount of the acid dianhydride used for preparation of the oligomer may be 0.008 times or more, 0.01 times or more, 0.015 times or more or 0.02 times or more, and 0.15 times or less, 0.12 times or less, 0.1 times or less or 0.08 times or less the total amount of the acid dianhydride, in terms of a molar ratio.

<Imidization>

Polyimide can be obtained by cyclodehydration of the polyamic acid. For imidization in solution, a chemical imidization method is suitable in which a dehydration agent, an imidization catalyst and the like are added to the polyamic acid solution. The polyamic acid solution may be heated to accelerate the progress of imidization.

A tertiary amine is used as the imidization catalyst. As the tertiary amine, a heterocyclic tertiary amine is preferable. Specific examples of the heterocyclic tertiary amine include pyridine, picoline, quinoline and isoquinoline. As the dehydration agent, carboxylic acid anhydride is used, and specific examples thereof include acetic anhydride, propionic anhydride, n-butyric anhydride, benzoic acid anhydride and trifluoroacetic anhydride. The amount of the imidization catalyst may be 0.5 to 5.0 times, 0.7 to 2.5 times, or 0.8 to 2.0 times the amount of amide groups of the polyamic acid in terms of molar equivalent. The amount of the dehydration agent may be 0.5 to 10.0 times, 0.7 to 5.0 times, or 0.8 to 3.0 times the amount of amide groups of the polyamic acid in terms of molar equivalent.

<Precipitation of Polyimide Resin>

Although the polyimide solution obtained by imidization of the polyamic acid may be used as a dope for deposition as it is it is preferable that a polyimide resin is once precipitated as a solid substance. When the polyimide resin is precipitated as a solid substance, impurities and residual monomer components generated during polymerization of the polyamic acid, and the dehydration agent and the imidization catalyst and the like can be washed and removed. Thus, a polyimide film excellent in transparency and mechanical properties can be obtained.

By mixing the polyimide solution and the poor solvent, the polyimide resin is precipitated. The poor solvent is a poor solvent of the polyimide resin, preferably one miscible with a solvent in which the polyimide resin is dissolved, and examples thereof include water and alcohols. Examples of alcohols include methyl alcohol, ethyl alcohol, isopropyl alcohol, ethylene glycol, triethylene glycol, 2-butyl alcohol, 2-hexyl alcohol, cyclopentyl alcohol, cyclohexyl alcohol, phenol and t-butyl alcohol. The poor solvent may be an alcohol such as isopropyl alcohol, 2-butyl alcohol, 2-pentyl alcohol, phenol, cyclopentyl alcohol, cyclohexyl alcohol or t-butyl alcohol, or isopropyl alcohol, because the ring-opening of the polyimide or the like is less occurred.

[Polyimide Film]

A polyimide solution (dope for deposition) obtained by dissolving a polyimide resin in an organic solvent is applied onto a substrate, and the solvent is removed by drying to produce a polyimide film.

The organic solvent in which the polyimide resin is dissolved is not particularly limited as long as it can dissolve the polyimide resin. Low-boiling-point solvents such as dichloromethane, methyl acetate, tetrahydrofuran, acetone and 1,3-dioxolane are preferable, with dichloromethane being particularly preferable, because these solvents are easily removed by drying, and the residual solvent in the polyimide film can be reduced. As described above, when the composition ratio of the acid dianhydride component and the diamine component is in a specific range, a polyimide having high solubility even in a low-boiling-point solvent such as dichloromethane can be obtained.

The solid content concentration of the polyimide solution may be appropriately set according to the molecular weight of the polyimide, the film thickness, the film forming environment, and the like. The solid content concentration may be 5 to 30 wt %, or 8 to 20 wt %.

The polyimide solution may contain resin components other than the polyimide, and additives. Examples of the additives include ultraviolet absorbers, crosslinkers, dyes, surfactants, leveling agents, plasticizers, and fine particles. As described above, when the polyimide resin contains an acid dianhydride having a biphenyl structure as acid dianhydride component, a polyimide film having excellent light resistance (ultraviolet durability) even if an ultraviolet absorber is not used. The content of the polyimide resin based on 100 parts by weight of the solid content of the polyimide solution (deposition dope) may be 60 parts by weight or more, 70 parts by weight or more, or 80 parts by weight or more.

As a method for applying the polyimide solution to the substrate, a known method can be used, and the polyimide solution can be applied by for example, a bar coater or a comma coater. As the substrate to which the polyimide solution is applied, a glass substrate, a metal substrate, a metal drum or a metal belt made of SUS or the like, a plastic film, or the like can be used. From the viewpoint of improving productivity, it is preferable to produce a film by a roll-to-roll process using an endless support such as a metal drum or a metal belt, a long plastic film or the like as a support. When a plastic film is used as the support, a material that is not soluble in a deposition dope solvent may be appropriately selected, and as the plastic material, polyethylene terephthalate, polycarbonate, polyacrylate, polyethylene naphthalate or the like is used.

It is preferable to perform heating the solvent during drying. Although the heating temperature is not particularly limited, the heating temperature may be 200° C. or lower, or 180° C. or lower, from the viewpoint of suppressing coloring. In drying the solvent, the heating temperature may be elevated stepwise. The solvent may be dried under reduced pressure. Since the polyimide resin is soluble in a low-boiling-point solvent such as dichloromethane, the residual solvent can be easily reduced even by heating at 200° C. or lower.

The residual solvent in the polyimide film (ratio of the mass of the solvent contained in the film to the mass of the film) may be 1.5% or less, or 1.0% or less. When the residual solvent is in this range, the mechanical strength of the polyimide film tends to be improved.

The thickness of the polyimide film is not particularly limited, and may be appropriately set in accordance with the intended use. The thickness of the polyimide film is, for example, about 5 to 100 μm. When the polyimide film is used for cover window materials for displays and the like, which are required to have impact resistance, the thickness of the polyimide film may be 30 μm or more, 35 μm or more, or 40 μm or more. The polyimide film of one or more embodiments of the present invention has excellent transparency even when the thickness is as large as 40 μm or more. From the viewpoint of maintaining excellent transparency, the thickness of the polyimide film may be 90 μm or less, or 85 μm or less.

[Properties of Polyimide Film]

The yellowness index (YI) of the polyimide film may be 3.0 or less, or 2.5 or less. When the yellowness index is 3.0 or less, the film is not colored yellow, and can be suitably used as a film for displays and the like.

The total light transmittance of the polyimide film may be 80% or more, or 85% or more. The light transmittance of the polyimide film at a wavelength of 400 nm may be 40% or more.

The tensile modulus of the polyimide film may be 3.0 GPa or more, or 3.5 GPa or more. From the viewpoint of preventing contact with a roll during roll-to-roll transfer and scratching of the film due to contact between the films during winding, the pencil hardness of the polyimide film may be equal to or greater than HB, or equal to or greater than F. When the polyimide film is used for cover windows of displays and the like, the pencil hardness of the polyimide film may be equal to or greater than H because scratch resistance to contact from the outside is required.

The polyimide film of one or more embodiments of the present invention has a low yellowness index and high transparency and is suitably used as a display material. Further, the polyimide film has a high surface hardness, and is therefore applicable to surface members such as cover window of display. The difference in yellowness index (ΔYI) of the polyimide film before and after irradiation with an ultraviolet ray may be 10 or less, or 5 or less.

[Usage of Polyimide Film]

The polyimide film of one or more embodiments of the present invention has a low yellowness index and high transparency and is therefore suitably used as a display material. In particular, a polyimide film having high mechanical strength is applicable to surface members such as cover window of display. In practical use, an antistatic layer, an easily-adhesion layer, a hard coat layer, an antireflection layer and the like may be provided on a surface of the polyimide film of one or more embodiments of the present invention.

### EXAMPLES

Hereinafter, one or more embodiments of the present invention will be described in detail on the basis of examples and comparative examples. One or more embodiments of the present invention are not limited to the following examples.

(Solubility to Dichloromethane)

2 g of polyimide resin is added to 8 g of dichloromethane, the mixture was stirred at room temperature for 12 hours, and existence or non-existence of undissolved resin was visually checked. The polyimide resin was determined to be dichloromethane (DCM)-soluble when there was no undissolved resin, and the polyimide resin was determined to be DCM-insoluble when the resin was not dissolved, the resin was gelled, or undissolved resin was existed.

(Tensile Modulus)

For measurement, “AUTOGRAPH AGS-X” manufactured by Shimadzu Corporation was used, and the measurement was performed under the following conditions. Sample measurement range; width: 10 mm, distance between grippers: 100 mm, tensile speed: 20.0 mm/min, and measurement temperature: 23° C. As a sample, one left standing at 23° C./55% RH for 1 day to control the humidity was used.

(Yellowness)

The yellowness index (YI) was measured with a spectrophotometer “SC-P” manufactured by SugaTest Instruments Co., Ltd. using a sample of 3 cm square.

(Pencil Hardness)

The pencil hardness of the film was measured in accordance with JIS K-5600-5-4 “Pencil scratch test”.

(Transmittance at 400 nm)

With the use of an ultraviolet-visible spectrophotometer “V-560” manufactured by JASCO Corporation, the light transmittance of the film at 300 to 800 nm was measured, and the light transmittance at a wavelength of 400 nm was read.

(Total Light Transmittance and Haze)

Measurement was performed by the method described in JIS K7361-1 and JIS K7136 using a haze meter “HZ-V3” manufactured by Suga Test Instruments Co., Ltd.

(Residual Solvent Content)

About 0.1 g of a polyimide film and about 1 g of diethylene glycol butyl methyl ether (DEGBME) as an internal standard were dissolved in about 8.9 g of 1,3-dioxane as a solvent. This solution was measured with a gas chromatography device (GC manufactured by Shimadzu Corporation), and the residual solvent (dichloromethane, methyl ethyl ketone and others) in the polyimide film was determined from the GC peak area and the prepared concentration.

The abbreviations of monomers in Examples, Comparative Examples and Reference Examples are as follows.

TMHQ: p-phenylene bis(trimellitic acid monoester acid anhydride)

TAHMBP: bis(1,3-dioxo-1,3-dihydroisobenzofuran-5-carboxylic acid)2,2′,3,3′,5,5′-hexamethylbiphenyl-4,4′-diyl

6FDA: 2,2-bis(3,4-dicarboxyphenyl-1,1,1,3,3,3-hexafluoropropanoic acid dianhydride

BPDA: 3,3′,4,4′-biphenyltetracarboxylic acid dianhydride

CBDA: 1,2,3,4-cyclobutanetetracarboxylic acid dianhydride

TFMB: 2,2′-bis(trifluoromethyl)benzidine

3,3′-DDS: 3,3′-diaminodiphenylsulfone

### Example 1

(Preparation of Polyamic Acid Solution)

5.106 g (15.9 mmol) of TFMB, 1.697 g (6.83 mmol) of 3,3′-DDS and 72.3 g of N,N-dimethylformamide (hereinafter, referred to as “DMF”) were put into a separable flask, and the mixture was stirred in a nitrogen atmosphere to obtain a diamine solution. 6.897 g (11.2 mmol) of TAHMBP and 5.059 g (11.4 mmol) of 6FDA were added, and the mixture was stirred for 12 hours to obtain a polyamic acid solution having a solid content concentration of 18% and a viscosity of 244 poise at 23° C.

(Imidization, Isolation of Polyimide Resin and Preparation of Polyimide Solution)

To the above-described polyamic acid solution. 28.9 g of DMF and 5.405 g of pyridine as an imidization catalyst were added, and completely dispersed, 6.976 g of acetic anhydride was then added, and the mixture was stirred at 80° C. for 4 hours. The solution cooled to room temperature, and while the solution was stirred, a mixed solution of 85 g of 2-propyl alcohol (hereinafter referred to as “IPA”) and 15 g of DMF was added dropwise at a rate of 2 to 3 drops/sec to precipitate a polyimide. Further, 300 g of IPA was added, and the mixture was stirred for about 30 minutes, and filtration was performed with a Kiriyama funnel. The obtained solid was washed with 100 g of IPA. The washing operation was repeated 6 times, the solid was then dried in a vacuum oven set at 120° C. for 8 hours to obtain a polyimide resin.

(Preparation of Polyimide Film)

The polyimide resin was dissolved in dichloromethane (hereinafter, referred to as “DCM”) to obtain a polyimide solution having a solid content concentration of 10 wt %. A polyimide solution was applied to an alkali-free glass plate with a bar coater, and heated in an air atmosphere at 40° C. for 60 minutes, at 80° C. for 30 minutes, at 150° C. for 30 minutes and at 170° C. for 30 minutes to remove the solvent. In this way a polyimide film having a thickness of 78 μm was obtained.

### Examples 2 and 3

The coating thickness of the polyimide solution on the glass plate was changed to adjust the thickness of the polyimide film as shown in Table 1. Except for above, the same procedure as in Example 1 was carried out to obtain a polyimide film.

### Examples 4 to 15 and Comparative Examples 1 to 3

Except that the types and the amounts (molar ratios) of the acid dianhydrides and diamines were changed as shown in Tables 1 and 2, the same procedure as in Example 1 was carried out to prepare polyamic acids. With the use of the obtained polyamic acids, imidization, isolation of a polyimide resin, preparation of a polyimide solution and production of a polyimide film were performed.

### Comparative Example 4

Except that the types and the amounts (molar ratios) of the acid dianhydrides and diamines were changed as shown in Table 2, the same procedure as in Example 1 was carried out to prepare a polyamic acid solution. With the use of the obtained polyamic acids, imidization and isolation of a polyimide resin were performed. Since the obtained polyimide resin was insoluble in DCM, the polyimide resin was dissolved in methyl ethyl ketone (MEK) to prepare a polyimide solution having a solid content concentration of 10%. With the use of this polyimide solution, a polyimide film was produced in the same manner as in Example 1.

### Comparative Example 5

Except that the types and the amounts (molar ratios) of the acid dianhydrides and diamines were changed as shown in Table 2, the same procedure as in Example 1 was carried out to prepare a polyamic acid solution (solid content concentration: 18% and viscosity at 23° C.: 568 poise). DMF was added to the obtained polyamic acid solution to dilute the solution, an imidization catalyst and a dehydration agent were added, the mixture was stirred at 80° C. for 4 hours, and then cooled to room temperature, which resulted in solidification 420 g of IPA was added thereto, and suction filtration was performed with a Kiriyama funnel. The obtained solid was washed 3 times with 400 g of IPA, and then dried in a vacuum oven set at 120° C. for 8 hours to obtain a polyimide resin. This polyimide resin was insoluble in DCM, and therefore formation of a film was not carried out.

### Comparative Examples 6 and 7

Except that the types and the amounts (molar ratios) of the acid dianhydrides and diamines were changed as shown in Table 2, the same procedure as in Example 1 was carried out to prepare a polyamic acid solution. An imidization catalyst and a dehydration agent were added to the obtained polyamic acid solution to perform imidization, and as in Comparative Example 5, the solution was cooled to room temperature, which resulted in solidification. As in Comparative Example 5, washing was performed to obtain a polyimide resin, and in each of Comparative Examples 6 and 7, the obtained polyimide resin was insoluble in DCM, and therefore formation of a film was not carried out.

Tables 1 and 2 show the compositions of the polyimide resins of Examples and Comparative Examples (molar ratios of the amounts of acid dianhydrides and diamines in polymerization of polyamic acids), solubility of the polyimide resins in DCM, and evaluation results of the polyimide film.

TABLE 1

| | | | Example | Example | Example | Example | Example | Example | Example | Example |
|---|---|---|---|---|---|---|---|---|---|---|
| | | | 1 | 2 | 3 | 4 | 5 | 6 | 7 | 8 |
| Composition | Acid | TAHMBP | 50 | | | 60 | 25 | 25 | 25 | — |
| | dianhydride | TMHQ | — | | | — | — | — | 25 | 25 |
| | (mol %) | 6FDA | 50 | | | 40 | 75 | 50 | 50 | 75 |
| | | BPDA | — | | | — | — | 25 | — | — |
| | | CBDA | — | | | — | — | — | — | — |
| | Diamine | TFMB | 70 | | | 70 | 70 | 70 | 70 | 70 |
| | (mol %) | 3,3′-DDS | 30 | | | 30 | 30 | 30 | 30 | 30 |
| DCM solubility | | | Soluble | | | Soluble | Soluble | Soluble | Soluble | Soluble |
| Film | Film | μm | 78 | 49 | 29 | 67 | 77 | 73 | 77 | 72 |
| properties | thickness | | | | | | | | | |
| | Tensile | GPa | 4.2 | 4.3 | 4.2 | 4.1 | 3.9 | 4.2 | 4.2 | 3.8 |
| | modulus | | | | | | | | | |
| | Pencil | | 4H | 4H | 3H | 4H | 2H | 2H | 2H | 2H |
| | hardness | | | | | | | | | |
| | YI | | 1.8 | 1.7 | 1.6 | 2.2 | 1.6 | 1.9 | 1.9 | 1.8 |
| | 400 nm | % | 56 | 63 | 72 | 56 | 66 | 47 | 56 | 67 |
| | transmittance | | | | | | | | | |
| | Total light | % | 89 | 89 | 89 | 89 | 90 | 89 | 89 | 89 |
| | transmittance | | | | | | | | | |
| | Haze | % | 0.4 | 0.4 | 0.5 | 1.3 | 0.4 | 0.4 | 0.2 | 0.3 |
| | Residual | % | 0.8 | 0.1 | N.D. | 0.7 | 0.5 | 1.0 | 0.9 | 0.9 |
| | solvent | | | | | | | | | |

| | | | Example | Example | Example | Example | Example | Example | Example |
|---|---|---|---|---|---|---|---|---|---|
| | | | 9 | 10 | 11 | 12 | 13 | 14 | 15 |
| Composition | Acid | TAHMBP | — | — | — | — | | — | — |
| | dianhydride | TMHQ | 25 | 50 | 15 | 25 | | 25 | 40 |
| | (mol %) | 6FDA | 75 | 50 | 50 | 50 | | 50 | 50 |
| | | BPDA | — | — | 35 | 25 | | 25 | 10 |
| | | CBDA | — | — | — | — | | — | — |
| | Diamine | TFMB | 100 | 70 | 70 | 70 | | 100 | 70 |
| | (mol %) | 3,3′-DDS | — | 30 | 30 | 30 | | — | 30 |
| DCM solubility | | | Soluble | Soluble | Soluble | Soluble | | Soluble | Soluble |
| Film | Film | μm | 85 | 82 | 79 | 73 | 49 | 76 | 80 |
| properties | thickness | | | | | | | | |
| | Tensile | GPa | 3.7 | 4.0 | 4.0 | 4.0 | 4.1 | 4.2 | 3.6 |
| | modulus | | | | | | | | |
| | Pencil | | 3H | 3H | 3H | 3H | 3H | H | 3H |
| | hardness | | | | | | | | |
| | YI | | 1.9 | 2.5 | 2.4 | 2.3 | 1.8 | 2.7 | 2.6 |
| | 400 nm | % | 63 | 55 | 38 | 45 | 56 | 37 | 51 |
| | transmittance | | | | | | | | |
| | Total light | % | 90 | 89 | 89 | 89 | 89 | 89 | 89 |
| | transmittance | | | | | | | | |
| | Haze | % | 0.9 | 0.9 | 0.5 | 0.5 | 0.3 | 0.8 | 0.4 |
| | Residual | % | 0.8 | — | — | 0.9 | 0.1 | — | — |
| | solvent | | | | | | | | |

TABLE 2

| | | | Comparative | Comparative | Comparative | Comparative | Comparative | Comparative | Comparative |
|---|---|---|---|---|---|---|---|---|---|
| | | | Example 1 | example 2 | Example 3 | Example 4 | Example 5 | Example 6 | Example 7 |
| Composition | Acid | TAHMBP | 100 | | — | — | — | — | — |
| | dianhydride | TMHQ | — | | — | — | 75 | — | — |
| | | 6FDA | — | | 100 | 30 | 25 | — | 50 |
| | | BPDA | — | | — | — | — | 100 | 50 |
| | | CBDA | — | | — | 50 | — | — | — |
| | Diamine | TFMB | 100 | | 100 | 70 | 100 | 100 | 70 |
| | (mol %) | 3,3′-DDS | — | | — | 30 | — | — | 30 |
| DCM solubility | | | Soluble | | Soluble | Insoluble * | Insoluble | Insoluble | Insoluble |
| Film | Film | μm | 81 | 51 | 78 | 80 | | | |
| properties | thickness | | | | | | | | |
| | Tensile | GPa | 5.0 | 4.8 | 3.5 | 4.1 | | | |
| | modulus | | | | | | | | |
| | Pencil | — | 4H | 4H | F | 4H | | | |
| | hardness | | | | | | | | |
| | YI | — | 3.1. | 2.6 | 1.4 | 1.8 | | | |
| | 400 nm | % | 37.7 | 51.2 | 75.4 | 82.0 | | | |
| | transmittance | | | | | | | | |
| | Total light | % | 87.9 | 89.2 | 90.8 | 91.1 | | | |
| | transmitance | | | | | | | | |
| | Haze | % | 1.2 | 0.3 | 0.8 | 0.8 | | | |
| | Residual | % | — | 0.1 | — | 4.4 | | | |
| | solvent | | | | | | | | |

* Comparative Example 4 shows the properties of a film prepared using methyl ethyl ketone as a solvent

As shown in Table 1, it is apparent that when the constituent ratio of the acid dianhydride component and the diamine component which form the polyimide is an appropriate range, it is possible to exhibit a proper balance of solubility in dichloromethane (and the associated low residual solvent) and properties such as transparency and mechanical strength.

From comparison of Examples 1, 4 and 5 in which TAHMBP and 6FDA as acid dianhydrides were used and the ratios of these components were changed, it is apparent that Examples 1 and 4 with a high ratio of TAHMBP and a low ratio of 6FDA show a higher pencil hardness over Example 5.

From comparison between Examples 5 and 6 and comparison between Examples 9 and 12, it is apparent that Examples 6 and 9 in which 6FDA was partially replaced with BPDA show a higher tensile modulus as compared to Examples 5 and 9. In Comparative Example 7 in which TAHMBP in Example 1 was wholly replaced with BPDA the polyimide resin did not have solubility in dichloromethane. Therefore, it is apparent that when a bis-trimellitic anhydride ester such as TAHMBP is used as acid dianhydride, the solubility of the polyimide resin tends to be improved.

The polyimide resin of Comparative Example 5 with a small content of 6FDA did not have solubility in dichloromethane. On the other hand, in Comparative Example 3 with only 6FDA used as acid dianhydride, the polyimide resin had solubility in dichloromethane, and a polyimide film having high transparency was obtained, but the mechanical strength was insufficient.

The polyimide films of Examples with dichloromethane (boiling point: 40° C.) used as a solvent for the deposition dope (except for Examples 10, 11, 14 and 15 in which the residual solvent was not measured) all had a residual solvent of 1.0% or less. On the other hand, for the polyimide film of Comparative Example 4 using methyl ethyl ketone (boiling point: 80° C.) as an organic solvent for the deposition dope, the residual solvent of a film produced under conditions identical to those of examples was as high as 4.4%, it was necessary to perform drying for a longer time in order to reduce the residual solvent and thus film productivity was not sufficient.

The polyimide film of Example 1 had a low yellowness index even at a thickness of about 80 μm, and had excellent transparency. On the other hand, the polyimide film of Comparative Example 1 in which only TAHMBP was used as acid dianhydride had the yellowness index of 3.1, and Comparative Example 2 in which the thickness reduced to about 50 μm had the yellowness index of more than 2.5. In Comparative Examples 1 and 2, the cause of coloring may be that the TAHMBP content is high and the influence of intramolecular and/or intermolecular charge transfer of the polyimide have a strong impact.

From the above results, a polyimide containing a bis-trimellitic anhydride ester and a fluorine-containing aromatic acid dianhydride at a specific ratio as acid dianhydrides, and containing a fluoroalkyl-substituted benzidine as diamine enables formation of a film having high solubility in dichloromethane, allowing the residual solvent to be reduced, and having high mechanical strength and transparency.

<Evaluation of Film Thickness Variation>

The polyimide resins produced in Examples 1, 11, 12 and 15 were dissolved in dichloromethane to prepare a polyimide solution having a solid content concentration of 17%, and a polyimide film having a thickness of about 50 μm was produced. A portion occupying 10% at each of both ends in the width direction of the obtained polyimide film was cut of and for a region (150 mm) occupying 80% in central portion of the polyimide film, a thickness variation in the width direction was measured with a continuous thickness meter “TOF5R” from Yamabun Electronics Co., Ltd. The thickness of the film obtained using the polyimide resin of Example 1 was 48±0.8 μm, the thickness of the film obtained using the polyimide resin of Example 11 was 4±0.9 μm, and the thickness of the film obtained using the polyimide resin of Example 12 was 49±0.9 μm, and the thickness of the film obtained using the polyimide resin of Example 15 was 40±1.0 μm. For all the films, the thickness variation was within 1.0 μm.

### Comparative Example 8

100 parts by weight of the polyimide resin produced in Comparative Example 3 was dissolved in 900 parts by weight of dichloromethane to prepare a polyimide solution having a solid content concentration of 10 wt %, 2.5 parts by weight of “Tinuvin 1600” manufactured by BASF was added to this solution as an ultraviolet absorber. With the use of this solution, a polyimide film was produced in the same manner as in Comparative Example 3.

<Evaluation of Ultraviolet Resistance>

With the use of a UV lamp “UVM-57” manufactured by Analytik Jena, the film was irradiated with an ultraviolet ray having a wavelength of 400 nm or less (intensity: 5.3 mW/cm²) for 72 hours in an atmosphere at 23° C. The yellowness index (YI) of the film after irradiation with an ultraviolet ray was measured, and a change in yellowness index (ΔYI) of the film before and after irradiation was calculated. Same evaluation was performed for Examples 1, 6, 7, 10, 11, 12.15 and Comparative Example 3.

<Evaluation of Heat Resistance>

The film was placed in an oven at 250° C. for 30 minutes, and then taken out, and the yellowness index of the film after heating (YI after heating) was measured. Same evaluation was performed for Examples 1, 6, 7, 12 and Comparative Example 3.

Table 3 shows the composition of the polyimide resin, the amount of the ultraviolet absorber and the evaluation results in Comparative Example 8 together with the evaluation results in Examples 1, 6, 7, 10, 11, 12, 15 and Comparative Example 3.

TABLE 3

| | | | | | | | | | | Compar- | Compar- |
|---|---|---|---|---|---|---|---|---|---|---|---|
| | | | Example | Example | Example | Example | Example | Example | Example | ative | ative |
| | | | 1 | 6 | 7 | 10 | 11 | 12 | 15 | Example 3 | Example 8 |
| Composition | Acid | TAHMBP | 50 | 25 | 25 | — | — | — | — | — | — |
| | dianhydride | TMHQ | — | — | 25 | 50 | 15 | 25 | 40 | — | — |
| | (mol %) | 6FDA | 50 | 50 | 50 | 50 | 50 | 50 | 50 | 100 | 100 |
| | | BPDA | — | 25 | — | — | 35 | 25 | 10 | — | — |
| | Diamine | TFMB | 70 | 70 | 70 | 70 | 70 | 70 | 70 | 100 | 100 |
| | | 3,3′-DDS | 30 | 30 | 30 | 30 | 30 | 30 | 30 | — | — |
| | Ultraviolet absorber | | — | — | — | — | — | — | — | — | 2.5 |
| | (parts by weight) | | | | | | | | | | |
| Film | Film | μm | 78 | 73 | 77 | 82 | 79 | 73 | 80 | 78 | 79 |
| properties | thickness | | | | | | | | | | |
| | Tensile | GPa | 42 | 4.2 | 4.2 | 4.0 | 4.0 | 4.0 | 3.6 | 3.5 | 3.4 |
| | modulus | | | | | | | | | | |
| | Pencil | — | 4H | 2H | 2H | 3H | 3H | 3H | 3H | F | F |
| | hardness | | | | | | | | | | |
| | YI | — | 1.8 | 1.9 | 1.9 | 2.5 | 2.4 | 2.3 | 2.6 | 1.4 | 2.4 |
| | 400 nm | % | 56 | 47 | 56 | 55 | 38 | 45 | 51 | 75 | 73 |
| | transmittance | | | | | | | | | | |
| | Total light | % | 89 | 89 | 89 | 89 | 89 | 89 | 89 | 91 | 90 |
| | transmittance | | | | | | | | | | |
| | Haze | % | 0.4 | 0.4 | 0.2 | 0.9 | 0.5 | 0.5 | 0.4 | 0.8 | 0.5 |
| | UV | — | 3.4 | 1.8 | 4.7 | 24.1 | 1.9 | 4.0 | 9.8 | 7.1 | 1.8 |
| | irradiation | | | | | | | | | | |
| | ΔYI | | | | | | | | | | |
| | After heating | — | 1.8 | 1.9 | 1.9 | — | — | 2.3 | — | 1.4 | 3.2 |
| | YI | | | | | | | | | | |

From comparison between Comparative Example 3 and Comparative Example 8, it is apparent that a polyimide film containing an ultraviolet absorber has a smaller ΔYI value after UV irradiation and thus has higher light resistance than a film free of an ultraviolet absorber. However, the yellowness index of the polyimide film of Comparative Example 8, which contained an ultraviolet absorber, increased when the film was heated at 250° C. This is because the ultraviolet absorber is thermally decomposed by heating, leading to an increase in coloring. As a result, the high heat resistance which is a feature of the polyimide resin is impaired.

The polyimide film of Example 10 in which only TMHQ and TFMB were used as acid dianhydride component has a ΔYI value of more than 20, and the light resistance is not sufficient. From comparison of Examples 11, 12 and 15 in which apart of TMHQ was replaced with BPDA which is a biphenyl structure-containing acid dianhydride, it is apparent that an increase in BPDA content decreases the ΔYI value and improves light resistance.

The polyimide film of Example 1 in which only TAHMBP and TFMB were used as acid dianhydride component has a small ΔYI value and excellent light resistance although BPDA is not present as acid dianhydride. This may be because TAHMBP has a biphenyl structure. Although the polyimide film of Example 7 in which TAHMBP and TMHQ were used in combination had a larger ΔYI as compared to Example 1, it showed sufficiently superior light resistance as compared with Example 10. In Example 6 in which a part of TAHMBP in Example 1 was replaced with BPDA, the ΔYI value was smaller as compared Example 1, and further excellent light resistance was exhibited.

These results show that by using an acid dianhydride having a biphenyl structure, light resistance (ultraviolet resistance) is enhanced, and even when an ultraviolet absorber is not used, a polyimide film having excellent light resistance can be obtained.

### Example 16

5.7 g (17.9 mmol of TFMB and 103 g of DMF were put into a separable flask, and the mixture was stirred in a nitrogen atmosphere to obtain a diamine solution. 10.1 g (16.3 mmol) of TAHMBP was added, and the mixture was stirred for 10 hours. The amount of diamine (TFMB) is about 1.10 mol times the amount of acid dianhydride (TAHMBP), and the calculated average of the numbers of repeating units in which TFMB and TAHMBP are combined is about 11. A polyamic acid having a block structure was prepared by the reaction between TFMB, and TAHMBP, 1.6 g (4.9 mmol) of TFMB, 2.4 g (9.8 mmol) of 3,3′-DDS and 7.2 g (16.2 mmol) of 6FDA were added, and the mixture was stirred for 5 hours to obtain a polyamic acid solution. With the use of the obtained polyamic acid solution, imidization, isolation of a polyimide resin, preparation of a polyimide solution and production of a polyimide film were performed in the same manner as in Example 1.

### Example 17

7.6 g (23.9 mmol) of TFMB and 103 g of DMF were put into a separable flask, and the mixture was stirred in a nitrogen atmosphere to obtain a diamine solution. 9.6 g (21.7 mmol) of 6FDA was added, and the mixture was stirred for 10 hours. Further, 2.1 g (6.5 mmol of TAHFMB, 3.2 g (13.2 mmol) of 3,3′-DDS and 13.4 g (21.6 mmol of TAHMBP were added, and the mixture was stirred for 5 hours to obtain a polyamic acid solution. With the use of the obtained polyamic acid solution, imidization, isolation of a polyimide resin, preparation of a polyimide solution and production of a polyimide film were performed in the same manner as in Example 1.

### Example 18

2.223 g (6.95 mmol) of TFMB and 72.3 g of DMF were put into a separable flask, and the mixture was stirred in a nitrogen atmosphere to obtain a diamine solution. 3.777 g (6.11 mmol of TAHMBP was added, and the mixture was stirred for 10 hours. The amount of diamine (TFMB) is about 1.13 mol times the amount of acid dianhydride (TAHMBP), and the calculated average of the numbers of repeating units in which TFMB and TAHMBP are combined is about 9. Further, 3.435 g (10.8 mmol) of TFMB, 1.880 g (7.57 mmol) of 3,3′-DDS, 5.606 g (12.6 mmol) of 6FDA and 1.856 g (6.31 mmol) of BPDA were added, and the mixture was stirred for 5 hours to obtain a polyamic acid solution. With the use of the obtained polyamic acid solution, imidization, isolation of a polyimide resin, preparation of a polyimide solution and production of a polyimide film were performed in the same manner as in Example 1.

The mechanical strength (tensile modulus and pencil hardness) of each of the polyimide films of Examples 16 to 18 was evaluated. Table 4 shows the evaluation results of Examples 1 and 6. In Table 4, acid dianhydrides and diamines (monomers used to form a block structure) added first are underlined.

TABLE 4

| | | | Example | Example | Example | Example | Example |
|---|---|---|---|---|---|---|---|
| | | | 1 | 16 | 17 | 6 | 18 |
| Composition | Acid | TAHMBP | 50 | 50 | 50 | 25 | 25 |
| | Dianhydride | 6FDA | 50 | 50 | 50 | 50 | 50 |
| | (mol %) | BPDA | — | — | — | 25 | 25 |
| | Diamine | TFMB | 70 | 70 | 70 | 70 | 70 |
| | (mol %) | | | (55/15) | (55/15) | | (28/42) |
| | | 3,3′-DDS | 30 | 30 | 30 | 30 | 30 |
| Sequence | | | Random | Block | Block | Random | Block |
| Film | Film | μm | 78 | 75 | 82 | 73 | 79 |
| properties | thickness | | | | | | |
| | Tensile | GPa | 4.2 | 4.7 | 3.9 | 4.2 | 4.5 |
| | modulus | | | | | | |
| | Pencil | — | 4H | 4H | H | 2H | 3H |
| | hardness | | | | | | |

In Example 16 in which TAHMBP and TFMB were first reacted to form a block structure, the tensile modulus of the polyimide film was higher as compared to the polyimide of Example 1 (random structure) in which all the monomers were introduced and reacted. Comparison between Example 6 (random structure) and Example 18 (block structure) shows a similar tendency. On the other hand, in Example 17 in which 6FDA and TFMB were first reacted to form a block structure, the tensile modulus and the pencil hardness of the polyimide film were lower as compared to Example 1.

These results show that a polyimide film having higher mechanical strength can be obtained by reacting monomer components with high rigidity in advance to form a block structure.

### Example 19

(Preparation of Prepolymer Solution)

11.057 g (34.5 mmol of TFMB, 3.785 g (15.2 mmol) of 3,3′-DDS and 132 g of DMF were put into a separable flask, and the mixture was stirred in a nitrogen atmosphere to obtain a diamine solution. 11.279 g (25.4 mmol) of 6FDA 3.785 g (12.7 mmol) of BPDA and 4.892 g (10.7 mmol of TMHQ were added, and the mixture was stirred for 12 hours.

(Preparation of Oligomer Solution) 0.1133 g (0.354 mmol) of TFMB, 0.3275 g (0.714 mmol) of TMHQ and 2.02 g of DMF were put into another flask, and the mixture was stirred for 1 hour to obtain a homogeneous solution.

When an oligomer solution was added to a prepolymer solution, and the mixture was stirred, reaction between the prepolymer and the oligomer proceeded, and the viscosity of the solution increased as the molecular weight rose. It took 2 hours until the increase in viscosity was saturated.

### Example 20

48.884 g (152.7 mmol) of TFMB, 16.250 g (65.4 mmol) of 3,3′-DDS and 584.1 g of DMF were put into a separable flask, and the mixture was stirred in a nitrogen atmosphere to obtain a diamine solution. 48.452 g (109.1 mmol of 6FDA, 16.05 g (54.5 mmol) of BPDA and 22.995 g (50.2 mmol) of TMHQ, were added and the mixture was stirred for 12 hours. Thereafter, 0.501 g (1.10 mmol) of TMHQ was added, and the mixture was stirred. It took 10 hours until TMHQ was dissolved and the increase in viscosity was saturated.

With the use of the polyamic acid solution obtained in Example 19 and the polyamic acid solution obtained in Example 20, imidization, isolation of a polyimide resin, preparation of a polyimide solution and production of a polyimide film were performed in the same manner as in Example 1. Evaluation of the properties of the obtained polyimide film showed that high transparency and excellent mechanical strength were exhibited as in Example 1, and there was no evident difference in properties of the polyimide film between Examples 19 and 20.

In Example 20, it took 10 hours until completion of reaction (saturation of an increase in viscosity) after addition of TMHQ powder, whereas in Example 19, the time until completion of reaction after mixing of the prepolymer and the oligomer was reduced to 2 hours. These results show that when an acid dianhydride is reacted with a diamine to prepare an oligomer solution in advance, and the oligomer solution is added to the system, the time required for preparation of the polyamic acid can be reduced, so that production efficiency can be improved.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. A polyimide film comprising a polyimide resin, wherein a polyimide of the polyimide resin includes a structure derived from an acid dianhydride and a structure derived from a diamine,
wherein the acid dianhydride contains 10 to 60 mol % of an acid dianhydride represented by the general formula (1), 30 to 80 mol % of a fluorine-containing aromatic acid dianhydride, and 10 to 40 mol % of 3,3′,4,4′-biphenyltetracarboxylic acid dianhydride, based on 100 mol % of a total of the acid dianhydride, and the diamine contains 40 to 80 mol % of a fluoroalkyl-substituted benzidine and 20 to 50 mol % of 3,3′-diaminodiphenylsulfone, based on 100 mol % of a total of the diamine, 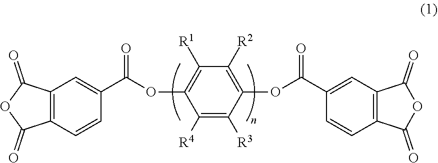
wherein, in the general formula (1), n=1, and R¹ to R⁴ are each independently a hydrogen atom, an alkyl group having 1 to 20 carbon atoms, or a perfluoroalkyl group having 1 to 20 carbon atoms,
wherein the polyimide resin is soluble in at least one solvent selected from the group consisting of dichloromethane, methyl acetate, tetrahydrofuran, acetone and 1,3-dioxolane, and
wherein the polyimide film has a yellowness index of 2.5 or less, a tensile modulus of 3.5 GPa or more, and a residual solvent content of 1.5 mass % or less.

2. The polyimide film according to claim 1, wherein the acid dianhydride represented by the general formula (1) contains an acid dianhydride represented by the formula (3):

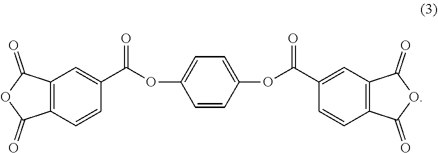

3. The polyimide film according to claim 1, wherein the acid dianhydride contains 40 to 80 mol % of the fluorine-containing aromatic acid dianhydride, based on 100 mol % of the total of the acid dianhydride.

4. The polyimide film according to claim 1, wherein a total of the acid dianhydride represented by the general formula (1), the fluorine-containing aromatic acid dianhydride and 3,3′,4,4′-biphenyltetracarboxylic acid dianhydride is 80 mol % or more, based on 100 mol % of the total of the acid dianhydride.

5. The polyimide film according to claim 1, wherein the fluorine-containing aromatic acid dianhydride is 2,2-bis(3,4-dicarboxyphenyl)-1,1,1,3,3,3-hexafluoropropanoic acid dianhydride.

6. The polyimide film according to claim 1, wherein the fluoroalkyl-substituted benzidine is 2,2′-bis(trifluoromethyl)benzidine.

7. The polyimide film according to claim 1, wherein the polyimide contains, in a molecular structure, a block consisting of successive repeating units in which the acid dianhydride represented by the general formula (1) and the fluoroalkyl-substituted benzidine are bonded.

8. A polyimide film comprising a polyimide resin, wherein a polyimide of the polyimide resin includes a structure derived from an acid dianhydride and a structure derived from a diamine,
wherein the acid dianhydride contains 10 to 60 mol % of an acid dianhydride represented by the general formula (1), 30 to 80 mol % of a fluorine-containing aromatic acid dianhydride and 0 to 40 mol % of 3,3′,4,4′-biphenyltetracarboxylic acid dianhydride, based on 100 mol % of a total of the acid dianhydride, and
the diamine contains 40 to 80 mol % of a fluoroalkyl-substituted benzidine and 20 to 50 mol % of 3,3′-diaminodiphenylsulfone based on 100 mol % of a total of the diamine, 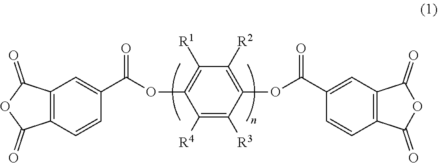
wherein, in the general formula (1), n=2, and R¹ to R⁴ are each independently a hydrogen atom, an alkyl group having 1 to 20 carbon atoms, or a perfluoroalkyl group having 1 to 20 carbon atoms,
wherein the polyimide resin is soluble in at least one solvent selected from the group consisting of dichloromethane, methyl acetate, tetrahydrofuran, acetone and 1,3-dioxolane, and
wherein the polyimide film has a yellowness index of 2.5 or less, a tensile modulus of 3.5 GPa or more, and a residual solvent content of 1.5 mass % or less.

9. The polyimide film according to claim 8, wherein the acid dianhydride represented by the general formula (1) contains an acid dianhydride represented by the formula (2):

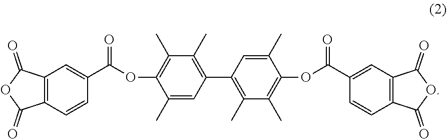

10. The polyimide film according to claim 8, wherein the acid dianhydride contains 40 to 80 mol % of the fluorine-containing aromatic acid dianhydride based on 100 mol % of the total of the acid dianhydride.

11. The polyimide film according to claim 8, wherein a total of the acid dianhydride represented by the general formula (1), the fluorine-containing aromatic acid dianhydride and 3,3′,4,4′-biphenyltetracarboxylic acid dianhydride is 80 mol % or more, based on 100 mol % of the total of the acid dianhydride.

12. The polyimide film according to claim 8, wherein the fluorine-containing aromatic acid dianhydride is 2,2-bis(3,4-dicarboxyphenyl)-1,1,1,3,3,3-hexafluoropropanoic acid dianhydride.

13. The polyimide film according to claim 8, wherein the fluoroalkyl-substituted benzidine is 2,2′-bis(trifluoromethyl)benzidine.

14. The polyimide film according to claim 8, wherein the polyimide contains, in a molecular structure, a block consisting of successive repeating units in which the acid dianhydride represented by the general formula (1) and the fluoroalkyl-substituted benzidine are bonded.

15. The polyimide film according to claim 8, wherein the polyimide film has a thickness of 40 μm or more.

16. The polyimide film according to claim 8, wherein the polyimide film has a pencil hardness of equal to or greater than H.

17. A production method of the polyimide film set forth in claim 1, the method comprising:
preparing the polyimide resin,
wherein the preparing the polyimide resin comprises:
preparing a polyamic acid solution by reacting diamine and acid dianhydride in a first solvent:
obtaining a first polyimide solution by adding an imidization catalyst and a dehydration agent to the polyamic acid solution to cause cyclodehydration of the polyamic acid;
precipitating the polyimide resin by mixing the first polyimide solution and a poor solvent for the polyimide resin; and
drying the polyimide resin,
preparing a second polyimide solution by dissolving the polyimide resin in a second solvent;
applying the second polyimide solution onto a substrate; and
removing the solvent,
wherein the second solvent includes at least one selected from the group consisting of dichloromethane, methyl acetate, tetrahydrofuran, acetone and 1,3-dioxolane.

18. The method of claim 17, wherein the second solvent includes dichloromethane.

19. A production method of the polyimide film set forth in claim 8, the method comprising:
preparing the polyimide resin,
wherein the preparing the polyimide resin comprising:
preparing a polyamic acid solution by reacting diamine and acid dianhydride in a first solvent;
obtaining a first polyimide solution by adding an imidization catalyst and a dehydration agent to the polyamic acid solution to cause cyclodehydration of the polyamic acid;
precipitating the polyimide resin by mixing the first polyimide solution and a poor solvent for the polyimide resin; and
drying the polyimide resin,
preparing a second polyimide solution by dissolving the polyimide resin in a second solvent;
applying the second polyimide solution onto a substrate; and
removing the solvent,
wherein the second solvent includes at least one selected from the group consisting of dichloromethane, methyl acetate, tetrahydrofuran, acetone and 1,3-dioxolane.

20. The method of claim 19, wherein the second solvent includes dichloromethane.
